(19) United States
(12) Patent Application Publication
(10) Pub. No.: US 2026/0307859 A1
(43) Pub. Date: Oct. 8, 2026

(54) SECURITY AND ANTI-TAMPER DEVICE FOR CONTAINERS

(71) Applicant: Scorpion Security Products, Inc., Vestal, NY (US)

(72) Inventors: Adam Bixby, Endicott, NY (US); Franklyn W. Gulick, JR., Binghamton, NY (US); Grant William Gulick, Endwell, NY (US)

(73) Assignee: Scorpion Security Products, Inc., Vestal, NY (US)

(21) Appl. No.: 19/638,520

(22) Filed: Apr. 3, 2026

Related U.S. Application Data
(60) Provisional application No. 63/785,198, filed on Apr. 8, 2025.

(51) Int. Cl. B65D 25/20; B65D 55/14

(52) U.S. Cl. CPC B65D 25/205; B65D 55/14; B65D 2203/10; B65D 2211/00

(57) ABSTRACT

A security device for securing a container including a body with a top surface, a bottom surface and one or more side surfaces defining. A securing member extends from a first end to a second end and is movably coupled to the body. The securing member includes a retainer at the first end and is configured to interact with the bottom of the body to guide a movement of the securing member relative to the body. In the locked state, the body is positioned on top of a container and the securing member is moved in the second direction to trap a top portion of the container between the one or more side surfaces and the retainer. In the locked state, the securing member is inhibited from moving in the second direction.

### CROSS-REFERENCE TO RELATED APPLICATION

This application claims priority to, and the benefit of, U.S. Provisional Patent Application Ser. No. 63/785,198, filed on Apr. 8, 2025. The entire contents of said application are hereby incorporated by reference.

### TECHNOLOGICAL FIELD

Embodiments of the disclosed invention relate generally to the field of retail security and specifically to a security device configured to removably attach to a container, such as a can, in order to inhibit removal of the container from a retail area and access to a contents of the container through the top of the container.

### BACKGROUND

Theft of containers of product, such as containers of food, is a common problem for retailers around the world. Waves of economic hardship and price inflation increases this problem, which in turn leads to increased losses for retailers. Installing and/or removing security tags or alarms that are currently used to protect such containers frequently damage the product itself. Consequently, the employees that are tasked with installation and removal of the security tag/alarm require specialized training to minimize damage to the product. Moreover, the currently used security tag/alarms interfere with neat/efficient stacking or display of the food containers on a display fixture.

In addition to protecting against theft, there is an ongoing importance to protect the container contents, such as in the case of food, from tampering. Currently used security tags and alarms are not effective in this purpose or are difficult to install and remove. Moreover, the currently used devices/systems to secure containers and inhibit tampering of their contents are expensive to employ, which prevents many retailers from being able to effectively address issues of theft and tampering.

These are just some of the problems associated with current security devices used to attach security tags/alarms to containers, such as cans containing food products.

### BRIEF SUMMARY OF THE DISCLOSURE

Aspects of the following disclosure are directed to embodiments of a security device for securing a container. In some embodiments, the security device includes a body including a top surface, a bottom surface including one or more guide surfaces, at least one inner surface, and one or more side surfaces. In some embodiments, the security device includes a securing member extending from a first end to a second end and movably coupled to the body. In some embodiments, the securing member includes a retainer at the first end and one or more guide members that extend along an axis between the first and second end of the securing member and interact with the one or more guide surfaces of the bottom of the body to guide a movement of the securing member relative to the body. In some embodiments, when the security device is in the unlocked state, the securing member is configured to move in a first direction and in a second direction. In some embodiments, when the security device is in the locked state, the securing member is configured to move in the first direction. In some embodiments, the first direction comprises a movement of the retainer towards the body and the second direction includes a movement of the retainer away from the body. In some embodiments, when the security device is on the locked state, the body is positioned on top of a container and the securing member is moved in the second direction to trap a top portion of the container between the one or more side surfaces and the retainer, and wherein the retainer is configured to engage a rim of the container.

In some embodiments, the security device further includes an RFID tag positioned in the body and configured to trigger when the body is removed from a retail space. In some embodiments, the security device further includes a biasing member positioned between the at least one inner surface and the second end of the securing member. In some embodiments, the biasing member is configured to bias the securing member in the second direction when in the unlocked state. In some embodiments of the security device, the one or more side surfaces include one or more retaining members configured to engage the rim of the container. In some embodiments of the security device, wherein the bottom surface of the body defines one or more openings dimensioned to engage portions of the container in order to securely attach the body to the container. In some embodiments of the security device, the container is a can of food. The security device of claim 1, further comprising at least one indicator configured to indicate a locked or an unlocked status. In some embodiments of the security device, when the body is installed on the container, the bottom surface faces a top surface of the container.

Aspects of the disclosure are directed to embodiments of a security device for securing a container. In some embodiments, the security device includes a body including a top surface, a bottom surface including one or more guide surfaces, and one or more side surfaces defining a perimeter. In some embodiments, the security device further includes a securing member extending from a first end to a second end and movably coupled to the body. In some embodiments, the securing member includes a retainer at the first end, and one or more guide members extending between the first and second end of the securing member and configured to interact with the one or more guide surfaces of the bottom of the body to guide a movement of the securing member relative to the body. In some embodiments, when the security device is in the unlocked state, the securing member is configured to move in a first direction and in a second direction. In some embodiments, when the security device is in the locked state, the securing member is configured to move in the first direction and is inhibited from moving in the second direction. In some embodiments of the security device, the retainer is moved towards the body in the first direction and the retainer is moved away from the body in the second direction. In some embodiments, when the security device is in the locked state, the body is positioned on top of a container and the securing member is moved in the second direction to trap a top portion of the container between the one or more side surfaces and the retainer. In some embodiments, the retainer is configured to engage a rim of the container.

In some embodiments of the security device, when the body is installed on the container, the bottom surface faces a top surface of the container. In some embodiments, the security device further includes an RFID tag positioned in the body and configured to trigger when the body is removed from a retail space. In some embodiments, the security device further includes a biasing member positioned between the body and the second end of the securing member. In some embodiments, the biasing member is configured to bias the securing member in the second direction when the security device is in the unlocked state. In some embodiments of the security device, the one or more side surfaces include one or more retaining members configured to engage the rim of the container. In some embodiments of the security device, the bottom surface of the body defines one or more openings dimensioned to engage portions of the container in order to securely attach the body to the container. In some embodiments of the security device, the top surface of the body is planar. In some embodiments, the security device further includes at least one indicator configured to indicate a locked or an unlocked status of the security device.

Aspects of the disclosure are directed to embodiments of a method of manufacturing a security device for securing a container. In some embodiments, the method includes structuring a body to comprise a top surface, a bottom surface including one or more guide surfaces, and one or more side surfaces defining a perimeter. In some embodiments, the method includes structuring a securing member to extend from a first end to a second end and to movably couple to the body. In some embodiments, the method includes structuring the securing member to comprise a retainer at the first end and one or more guide members extending between the first and second end of the securing member and configured to interact with the one or more guide surfaces of the bottom of the body to guide a movement of the securing member relative to the body. In some embodiments, the method includes structuring the securing member, when in the unlocked state, to move in a first direction and in a second direction that is different than the first direction. In some embodiments, the method includes structuring the securing member, when in the locked state, to move in the first direction and be inhibited from moving in the second direction. In some embodiments, the method includes structuring the body, when in the locked state, to be positioned on top of a container and structuring the securing member to be moved in the second direction to trap a top portion of the container between the one or more side surfaces and the retainer, and wherein the retainer is configured to engage a rim of the container. In some embodiments of the method, the first direction is movement of the retainer towards the body and the second direction is movement of the retainer away from the body.

In some embodiments, the method further includes structuring the body to include an RFID tag that is configured to trigger when the body is removed from a retail space. In some embodiment, the method further includes structuring a biasing member to be positioned between the body and the second end of the securing member and to bias the securing member in the second direction when in the security device is in the unlocked state. In some embodiments, the method further includes structuring the body to include at least one indicator configured to indicate the locked or the unlocked state of the device.

### BRIEF DESCRIPTION OF DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings.

FIG. 1A schematically illustrates an embodiment of a container that may be secured by embodiments of the security device, according to aspects of the disclosure.

FIG. 1B illustrates a top perspective view of an embodiment of a security device for a container, such as a food container or can, in a closed position and securing a can, according to aspects of the disclosure.

FIG. 2 illustrates a top perspective view of the embodiment of FIG. 1B in a closed position that is not securing a can, according to aspects of the disclosure.

FIG. 3 illustrates a top plan view of the embodiment of FIG. 2, according to aspects of the disclosure.

FIG. 4 illustrates a bottom plan view of the embodiment of FIG. 3, according to aspect of the disclosure.

FIG. 5 illustrates the embodiment of FIG. 3 in an open position, according to aspects of the disclosure.

FIG. 6 illustrates the embodiment of FIG. 4 in the open position, according to aspects of the disclosure.

### DETAILED DESCRIPTION

The following discussion relates to various embodiments of a security and anti-tamper device for a container. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the security and an anti-tamper device for a container and are not specifically provided to scale.

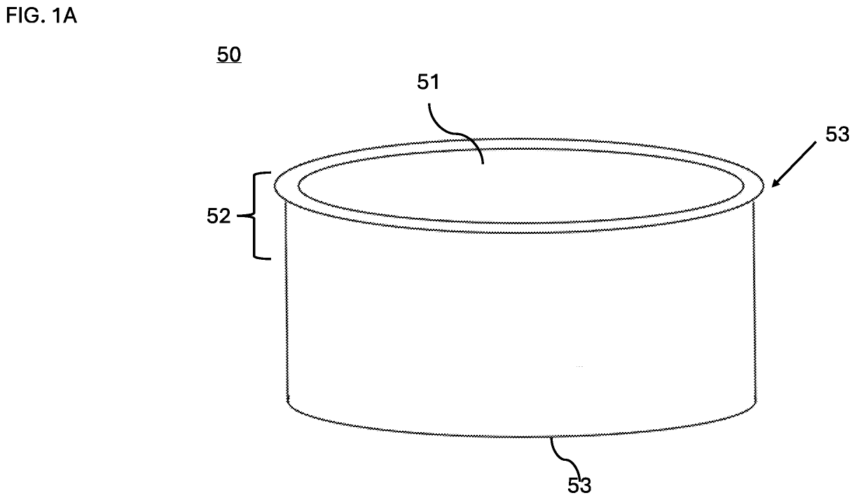

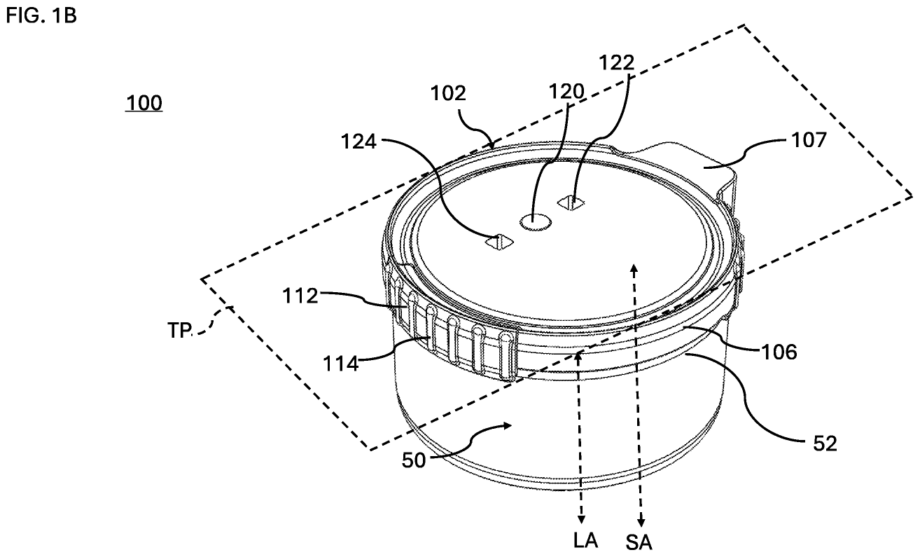

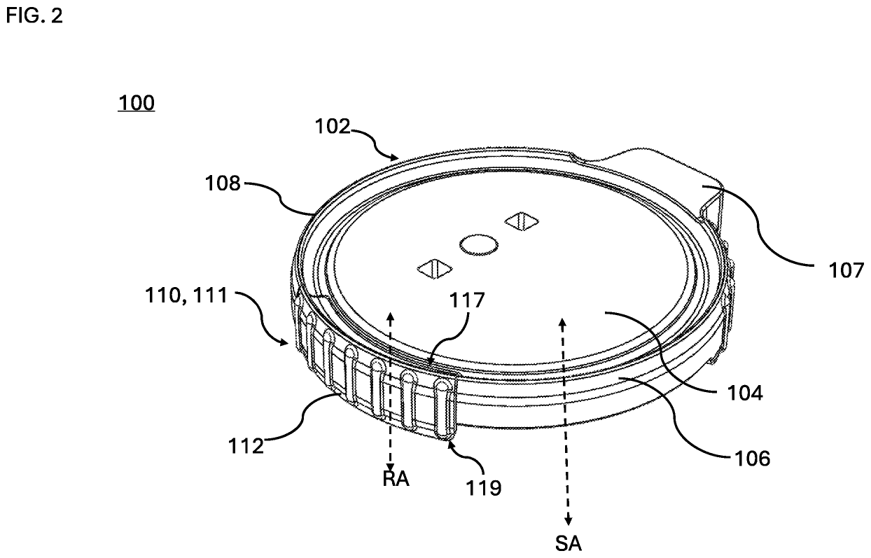

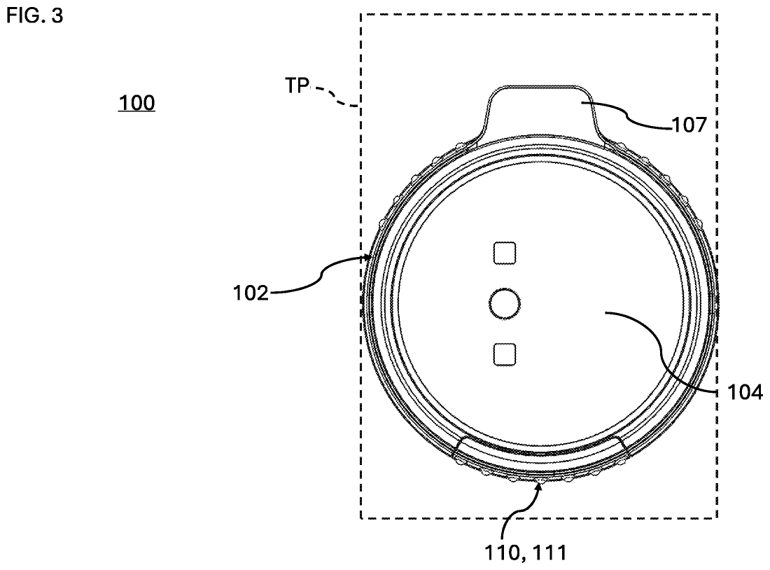

Referring to FIGS. 1A-6, some embodiments of a security and an anti-tamper device for a container 100 (security device) include a housing or body 102 having a top 104, one or more sides 106, and a bottom 105. In some embodiments, the one or more sides 106 define a circumference 108 or perimeter. In some embodiments, the one or more sides 106 are approximately circular. In some embodiments, the body 102 defines a compartment 107 structured to house an alarm and/or a security tag, such as an EAS alarming ferrite. In some embodiments, the top 104 of the body 102 extends along a top plane TP and the bottom 105 of the body 102 extends along a bottom plane BP that is approximately parallel to the top plane TP. In some embodiments, the container 50 to be secured includes a top (not shown) that extends along a container plane that is substantially parallel to the bottom plane BP. In some embodiments, the one or more sides extend along a side axis SA that intersects the top plane TP and the bottom plane BP. In some embodiments, the container included a rim 53 proximate the top 51 or positioned in a top portion 52 of the container 50. In some embodiments, the container is a can of food, such as an aluminum can that is sealed at the top 51 and bottom 55 and includes a rim 53 towards the top 51.

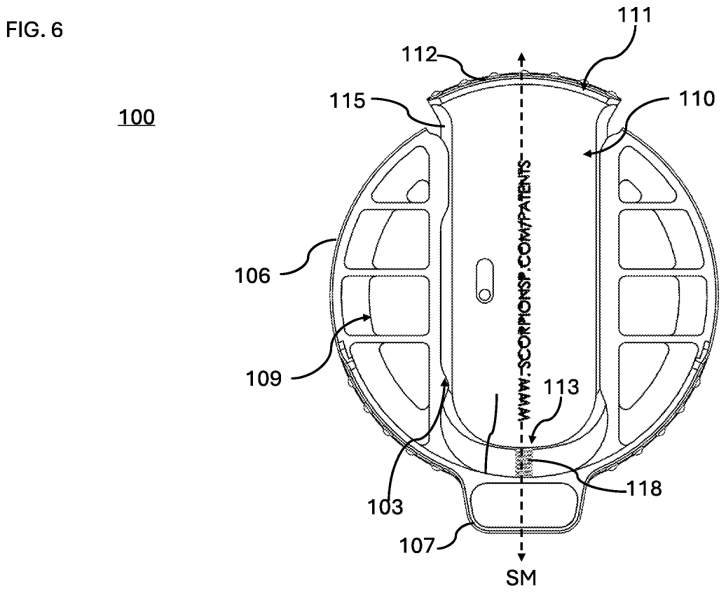

In some embodiments, the security device 100 includes a securing member 110 extending along an axis SM from a first end 111 to a second end 113 and that is moveably coupled to the body 102. In some embodiments, the securing member 110 includes a retainer 112. In some embodiments, the securing member 110 includes one or more surface features 114. In some embodiments, the one or more surface features 114 and the securing member 110 are formed as a single unitary component. In some embodiments, the retainer 112 forms part of the circumference 108 or perimeter. In some embodiments, the retainer 112 extends along a retainer axis RA that is approximately parallel to the side axis SA. In some embodiments, the retainer axis RA and the side axis SA are parallel to a longitudinal axis of the container LA (FIG. 1B). In some embodiments, the retainer 112 extends along the retainer axis RA from a first end 117 that is coupled to the securing member 110 and a second end 119 that extends beyond the adjacent one or more sides 106. Referring to FIG. 6, in some embodiments, the bottom 105 of the body 102 includes one or more guide surfaces that is configured to interact with one or more guide members 115 of the securing member 110 to direct the movement of the securing member 110 relative to the body 102. In some embodiments, the one or more guide surfaces 103 is formed as part of the body 102. In some embodiments, the movement comprises a sliding movement along the bottom plane BP.

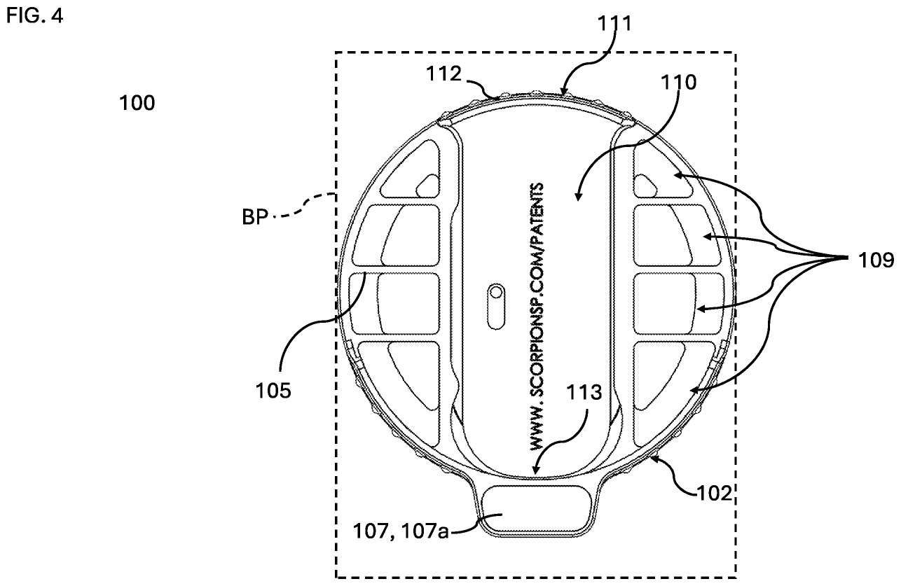

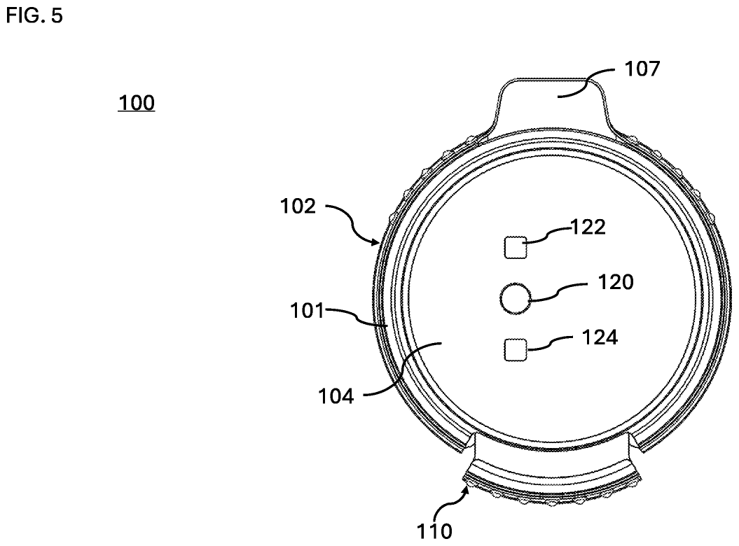

Referring to FIGS. 4 and 6, in some embodiments, the bottom 105 of the body 102 includes one or more retaining members 101 that extends at least partially about the perimeter. In some embodiments, the one or more retaining members 101 includes a lip or other such feature that is structured to removably attach to a rim 53 of the container 50. In some embodiments, the bottom 105 of the body 102 defines a plurality of cavities or recesses 109 that are positioned on either side of the securing member 110 when the securing member 110 is movably coupled to the body 102. In some embodiments, the plurality of cavities or recesses 109 may be dimensioned to further engage portions of the container 50 in order to assist in securely attaching the body 102 to the container 50. In some embodiments, the security device 100 includes a lock. Referring to FIG. 5, in some embodiments, the lock is positioned within the body 102 and the body includes a lock interface 120. In some embodiments, the lock is moved between a locked state and an unlocked state using a key that engages or otherwise contacts the lock interface 120. In some embodiments, the key comprises a magnet. In some embodiments, the lock includes a lock plate coupled to the body 102 that is moved into engagement with a lock portion of the securing member 110 to define the locked state and is disengaged from the lock portion in the unlocked state.

In some embodiments, when in the unlocked state, the securing member 110 is able to move in a first direction relative to the body 102 and in an opposing second direction relative to the body 102. In some embodiments, in the unlocked state, the lock plate and the lock portion The first direction and the second direction are different from each other. In some embodiments, when in the locked state, the securing member 110 is inhibited from moving in a first direction when in the locked state. In some embodiments, when in the locked state, the lock plate and lock portion are engaged with each other. In some embodiments, the movement in the first direction moves the retainer 112 away from the body 102 to define an open position as shown in FIGS. 5 and 6. In some embodiments, the movement in the second direction moves the retainer 112 towards the body 102 to define a closed position as shown in FIGS. 1-4. In some embodiments, the securing member 110 is biased in the open position with a biasing member 118 (FIG. 6) that is positioned between the second end 113 of the securing member 110 and an inner surface 102a of the body 102. In some embodiments, the biasing member 118 comprises a spring. In some embodiments, the body 102 includes at least one indicator 122, 124. In some embodiments, the body 102 includes two indicators 122, 124, where a first indicator 122 is configured to indicate the state of the lock (i.e., whether the lock is in the unlocked or locked state) and the second indicator is configured to indicate a state of the alarm (i.e., whether the alarm has been triggered and/or whether the alarm is activated).

Operation of the security device 100 will now be discussed with reference to FIGS. 1A-6. Starting from the open position shown in FIGS. 5 and 6, the security device 100 is placed over a container 50 as shown in FIGS. 1A and 1B so that the bottom 105 of the body 102 faces or is in contact with the top of the container 50 and the one or more retaining members 101 engages a top portion 52 of the container 50. In some embodiments, the top portion 52 of container includes a rim 53. In some embodiments, the top portion 52 of the container is completely covered by the security device 100 when it is installed onto the container 50. When the key is not contacting the lock interface 120, the security device 100 is in the locked state. The securing member 110 is moved relative to the body 102 in a first direction so that the retainer 112 is moved towards the body 102 until the container 50 is secured between the retainer 112 and the one or more sides 106. In some embodiments, the securing member 110 is moved relative to the body 102 in a first direction so that the retainer 112 is moved towards the body 102 until the container 50 is secured between the retainer 112 and the one or more retaining members 101. The security device 100 is now secured to the container 50 and the container 50 may be stocked on a display fixture. The security device 100 provides an easy way to attach a security tag 107a or alarm to the container 50 without damaging the container 50. The security device 100 further enables easy and neat stacking of the containers 50 on a display fixture with the security device 100 installed and while still being able to see the label on each container 50. If a container 50 with the security device 100 is attempted to be removed from the retail space, the alarm or security tag is triggered by one or more sensors positioned at the exits of the retail space. Moreover, if the security device is attempted to be removed from the container 50 in an unauthorized manner, such as without use of the key, the alarm/security tag is triggered to alert staff to the possible misdeeds.

In order to remove the security device 100 from the container 50, the key is brought into contact or engagement with the lock interface 120, which causes lock to move to the unlocked state so that the securing member 110 moves to the open position. In some embodiments, the securing member is biased into the open position such that once the lock is moved into the unlocked state, the securing member 110 “springs” from the closed position or otherwise automatically moves in a second direction such that the retainer 112 moves away from the body 102. In this manner, the security device 100 moves from the closed position to the open position. In some embodiments, the securing member 110 is manually moved in the second direction to disengage the container 50.

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1. A security device for securing a container, comprising:
a body including,
a top surface,
a bottom surface including one or more guide surfaces,
at least one inner surface, and
one or more side surfaces; and
a securing member extending from a first end to a second end and movably coupled to the body, the securing member including,
a retainer at the first end, and
one or more guide members extending along an axis between the first and second end of the securing member and configured to interact with the one or more guide surfaces of the bottom of the body to guide a movement of the securing member relative to the body,
wherein, in the unlocked state, the securing member is configured to move in a first direction and in a second direction,
wherein in the locked state, the securing member is configured to move in the first direction and is inhibited from moving in the second direction,
wherein, in the first direction, the retainer is moved towards the body, and
wherein, in the second direction, the retainer is moved away from the body,
wherein, in the locked state, the body is positioned on top of a container and the securing member is moved in the second direction to trap a top portion of the container between the one or more side surfaces and the retainer, and wherein the retainer is configured to engage a rim of the container.

2. The security device of claim 1, further comprising an RFID tag positioned in the body and configured to trigger when the body is removed from the retail space.

3. The security device of claim 1, further comprising a biasing member positioned between the at least one inner surface and the second end of the securing member, wherein the biasing member is configured to bias the securing member in the second direction when in the unlocked state.

4. The security device of claim 1, wherein the one or more side surfaces include one or more retaining members configured to engage the rim of the container.

5. The security device of claim 1, wherein the bottom surface of the body defines one or more openings dimensioned to engage portions of the container in order to securely attach the body to the container.

6. The security device of claim 1, wherein the container comprises a can of food.

7. The security device of claim 1, further comprising at least one indicator configured to indicate a locked or an unlocked status.

8. The security device of claim 1, wherein when the body is installed on the container, the bottom surface faces a top surface of the container.

9. A security device for securing a container, comprising:
a body including,
a top surface,
a bottom surface, and
one or more side surfaces defining a perimeter; and
a securing member extending from a first end to a second end and including a retainer at the first end, wherein the securing member is configured to interact with the bottom surface of the body to guide a movement of the securing member relative to the body,
wherein, in the unlocked state, the securing member is configured to move in a first direction and in a second direction,
wherein in the locked state, the securing member is configured to move in the first direction and is inhibited from moving in the second direction,
wherein, in the first direction, the retainer is moved towards the body, and
wherein, in the second direction, the retainer is moved away from the body,
wherein, in the locked state, the body is positioned on top of a container and the securing member is moved in the second direction to trap a top portion of the container between the one or more side surfaces and the retainer, and wherein the retainer is configured to engage a rim of the container.

10. The security device of claim 9, wherein when the body is installed on the container, the bottom surface faces a top surface of the container.

11. The security device of claim 9, wherein the bottom surface of the body comprises one or more guide surfaces, wherein the securing member includes one or more guide surfaces extending between the first and second end of the securing member, and wherein the one or more guide surfaces of the body are configured to interact with the one or more guide surface of the securing member to guide the movement of the securing member relative to the body.

12. The security device of claim 9, further comprising an RFID tag positioned in the body and configured to trigger when the body is removed from the retail space.

13. The security device of claim 9, wherein the one or more side surfaces include one or more retaining members configured to engage the rim of the container.

14. The security device of claim 9, wherein the bottom surface of the body defines one or more openings dimensioned to engage portions of the container in order to securely attach the body to the container.

15. The security device of claim 9, wherein the top surface of the body is planar.

16. The security device of claim 9, further comprising at least one indicator configured to indicate a locked or an unlocked status.

17. A method of manufacturing a security device for securing a container, comprising:
structuring a body to comprise,
a top surface,
a bottom surface, and
one or more side surfaces defining a perimeter; and
structuring a securing member to extend from a first end to a second end and to movably couple to the body;
structuring the securing member to comprise a retainer at the first end;
structuring the securing member, when in the unlocked state, to move in a first direction and in a second direction that is different than the first direction; and
structuring the securing member, when in the locked state, to move in the first direction and be inhibited from moving in the second direction;
structuring the body, when in the locked state, to be positioned on top of a container and structuring the securing member to be moved in the second direction to trap a top portion of the container between the one or more side surfaces and the retainer, and wherein the retainer is configured to engage a rim of the container,
wherein, in the first direction, the retainer is moved towards the body, and
wherein, in the second direction, the retainer is moved away from the body.

18. The method of claim 17, further comprising structuring the body to include an RFID tag that is configured to trigger when the body is removed from a retail space.

19. The method of claim 17, further comprising:
structuring the bottom surface of the body to include one or more guide surfaces; and
structuring the securing member to include one or more guide surfaces configured to extend between the first and second end of the securing member and to interact with the one or more guide surfaces of the bottom of the body to guide a movement of the securing member relative to the body.

20. The method of claim 17, further comprising structuring the body to include at least one indicator configured to indicate the locked or the unlocked state of the device.
